(19) United States
(12) Patent Application Publication
(10) Pub. No.: US 2023/0376806 A1
(43) Pub. Date: Nov. 23, 2023

(54) SYSTEM AND METHOD FOR DETERMINING A PATTERN FOR A SUCCESSFUL OPPORTUNITY AND DETERMINING THE NEXT BEST ACTION

(71) Applicant: Introhive Services Inc., Fredericton (CA)

(72) Inventors: Jody GLIDDEN, Miami Beach, FL (US); Peter MCGAW, Fredericton (CA); Jennifer LANDRY, Fredericton (CA)

(21) Appl. No.: 18/358,701

(22) Filed: Jul. 25, 2023

Related U.S. Application Data
(62) Division of application No. 16/939,739, filed on Jul. 27, 2020.
(60) Provisional application No. 62/879,096, filed on Jul. 26, 2019.
(60) Provisional application No. 62/887,959, filed on Aug. 16, 2019.
(60) Provisional application No. 62/927,488, filed on Oct. 29, 2019.
(60) Provisional application No. 62/879,107, filed on Jul. 26, 2019.

(51) Int. Cl. G06N 5/04; G06Q 30/016

(52) U.S. Cl. CPC G06N 5/04; G06Q 30/016

(57) ABSTRACT

System and method comprising selecting a set of opportunity patterns that are similar to an opportunity pattern of an open opportunity based on a first set of features; comparing the selected set of opportunity patterns to the opportunity pattern of the open opportunity based on a second set of features that are different than the first set of features; and generating feedback recommending a next action for the open opportunity based on the comparing.

### RELATED APPLICATIONS

This application a divisional of U.S. patent application Ser. No. 16/939,739, filed Jul. 27, 2020, the contents of which are incorporated herein by reference. It also claims the benefit of and priority to the following applications, the contents of which are incorporated herein by reference: (1) U.S. Provisional Patent Application No. 62/879,107 entitled “SYSTEM AND METHOD FOR ANALYSIS AND DETERMINATION OF A PATTERN FOR A SUCCESSFUL OPPORTUNITY”, filed Jul. 26, 2019; (2) U.S. Provisional Patent Application No. 62/879,096 entitled “SYSTEM AND METHOD FOR DETERMINING THE NEXT BEST ACTION TO CLOSE A SALES OPPORTUNITY SUCCESSFULLY”, filed Jul. 26, 2019; (3) U.S. Provisional Patent Application No. 62/887,959 entitled “SYSTEM AND METHOD FOR ANALYSIS AND DETERMINATION OF A PATTERN AND DOCUMENTS FOR A SUCCESSFUL OPPORTUNITY”, filed Aug. 16, 2019; and (4) U.S. Provisional Patent Application No. 62/927,488 entitled “SYSTEM AND METHOD FOR DETERMINING ACTION FROM OPPORTUNITY ANALYSIS”, filed Oct. 29, 2019.

### FIELD

The present disclosure relates to methods and systems for processing digital information about past activities and ongoing activities to predict future activities.

### BACKGROUND

Enterprises such as companies, accounting firms, law firms, universities, partnerships, agencies and governments commonly use customer relationship management (CRM) systems and related technology to manage relationships and interactions with other parties such as customers and potential customers. In particular, CRM systems typically employ electronic computing and communications devices that enable one or more of contact management, sales management and calendar management with the objective of enhancing productivity. An important function provided by CRM systems is digital tracking and storage of data about third parties such as customers and potential customers.

It is not uncommon for enterprises to have some salespeople that are very successful and other salespeople that are not as successful closing opportunities. Many of the differences between salespeople result from different communication methods, communication frequencies, and timing of the communications.

There are solutions that exist today that will help identify sales cycles and sales opportunities. These solutions often contain static advice such as “Make a follow-up contact with your client within 10 days of providing a demonstration”. This static feedback does not account for individual differences in selling style, or client type. Rather, such feedback is based on ‘Accepted Best Practices’ that have been aggregated over a plurality of companies selling into a plurality of different industries.

A problem with such solutions is that the ‘Accepted Best Practices’ are based on manual gathering and analysis of cross-industry data based on many subjective factors. Interpreting generalized accepted best practices in the context of an ongoing sales cycle by a specific sales person in a specific industry can result in generalized advice that is of limited value.

Accordingly, there is need for method and systems to gather and analyze data from past transactions, identify successful patterns, and the predict, based on data from an ongoing transaction and identified patterns what future actions should be taken to optimize a successful outcome.

The foregoing examples of the related art and limitations thereto are intended to be illustrative and not exclusive.

### SUMMARY

According to a first example aspect, a computer implemented method is provided that includes: determining a target pattern for a target opportunity by applying a set of predefined functions to data collected in respect of the target opportunity to generate a respective set of target features that numerically represent the target opportunity, the target features including a plurality of different type of features; selecting, based on a first subset of the set of target features, a set of similar opportunity patterns from a database of stored opportunity patterns, each of the stored opportunity patterns representing a respective closed opportunity as a respective set of opportunity features that numerically represent the respective closed opportunity, the opportunity features including the same types of features at the target features; comparing the selected set of similar opportunity patterns to the target pattern based on a second subset of the set of target features that are different types than the target features included in the first subset; and generating feedback recommending a next action for the target opportunity based on the comparing.

In one or more of the preceding example aspects, the stored opportunity patterns are each respectively generated by applying the same set of predefined functions applied to the data collected in respect of the target opportunity to data collected in respect of each of the respective closed opportunities.

In one or more of the preceding example aspects, the target features and the opportunity features each include types of features that are static features and types of features that are dynamic features, wherein static features represent properties that are expected to remain the same over a duration of an opportunity and dynamic features represent properties that are expected to change over the duration of the opportunity.

In one or more of the preceding example aspects, the first subset of the set of target features includes one or more static features, and the second subset of the set of target features includes one or more dynamic features.

In one or more of the preceding example aspects, the target opportunity exists between an enterprise organization and an account organization, and the dynamic features include features that measure a pattern of communication between the enterprise organization and an account organization at different defined stages during a duration of the target opportunity.

In one or more of the preceding example aspects, comparing the selected set of similar opportunity patterns to the target pattern comprises comparing patterns of communications for the target opportunity with patterns of communication for the selected set of similar opportunity patterns during the same stages.

In one or more of the preceding example aspects, selecting a set of similar opportunity patterns comprises performing a k-nearest neighbor algorithm to select the k-nearest opportunity patterns based on the first subset of the set of target features and the same-type features of the opportunity patterns of the closed opportunities.

In one or more of the preceding example aspects, generating feedback recommending a next action comprises sending a message through a network to a remote feedback interface that can be accessed by a user.

In one or more of the preceding example aspects, selecting the set of pre-defined functions from a group of pre-defined functions based on characteristics of the target opportunity.

In one or more of the preceding example aspects, the target opportunity is an open opportunity and the method is performed during a duration of the open opportunity.

In a further example aspect, a computer system is provided that includes a processor and a non-volatile storage coupled to the processer and including software instructions that when executed by the processor configure the computer system to: determine a target pattern for a target opportunity by applying a set of predefined functions to data collected in respect of the target opportunity to generate a respective set of target features that numerically represent the target opportunity, the target features including a plurality of different type of features; select, based on a first subset of the set of target features, a set of similar opportunity patterns from a database of stored opportunity patterns, each of the stored opportunity patterns representing a respective closed opportunity as a respective set of opportunity features that numerically represent the respective closed opportunity, the opportunity features including the same types of features at the target features; compare the selected set of similar opportunity patterns to the target pattern based on a second subset of the set of target features that are different types than the target features included in the first subset; and generate feedback recommending a next action for the target opportunity based on the comparing.

In a further example aspect, a computer implemented method is provided for selecting a set of opportunity patterns that are similar to an opportunity pattern of an open opportunity based on a first set of features; comparing the selected set of opportunity patterns to the opportunity pattern of the open opportunity based on a second set of features that are different types of features than the first set of features; and generating feedback recommending a next action for the open opportunity based on the comparing.

### BRIEF DESCRIPTION OF THE DRAWINGS

Reference will now be made, by way of example, to the accompanying drawings which show example embodiments of the present application, and in which:

FIG. 1 is a simplified block diagram illustrating an environment that includes a client network, CRM support system and CRM system in accordance with an example embodiment of the present disclosure.

FIG. 2 is a block diagram illustrating a pattern generation module of the CRM support system of FIG. 1, according to an example embodiment.

FIG. 3 is a flow diagram illustrating a process performed by the pattern generation module during a configuration mode.

FIG. 4 is a flow diagram illustrating a process performed a next best action module of the CRM support system of FIG. 1.

FIG. 5 is a simplified block diagram illustrating an example computer system for implementing one or more of the systems, modules and components shown in the environment of FIG. 1.

Similar reference numerals may have been used in different figures to denote similar components.

### DESCRIPTION OF EXAMPLE EMBODIMENTS

The following embodiments and aspects thereof are described and illustrated in conjunction with systems, tools and methods which are meant to be exemplary and illustrative, not limiting in scope.

Embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

System Overview

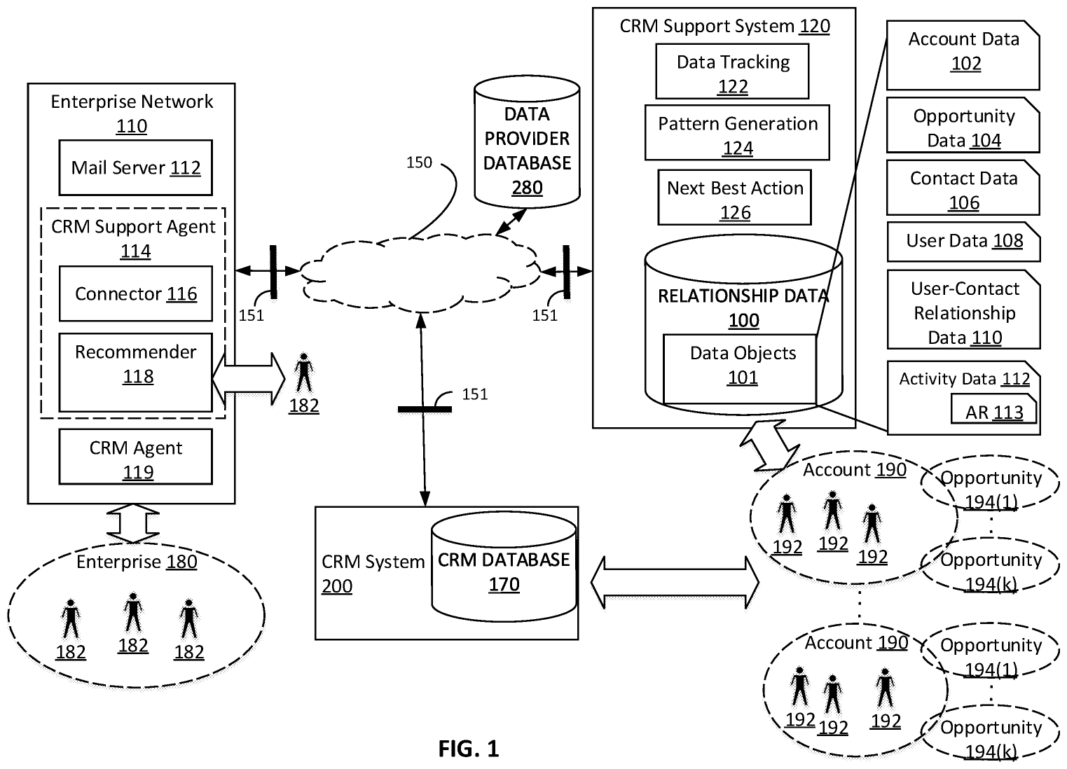

FIG. 1 illustrates an example environment in which the methods and systems described in this disclosure may be implemented. In the example of FIG. 1, environment includes an enterprise network 110 that supports an enterprise such as a company, firm or other type of organization (referred to in this disclosure as “enterprise 180”). In example embodiments, a plurality of individuals are registered or otherwise associated with the enterprise network 110 as users 182 of the enterprise 180. These individual users 182 may for example be employees, owners, partners, consultants, volunteers, and interns of the enterprise 180. In some examples, enterprise 180 could have as few as one user 182, and in some examples, enterprise 180 may have thousands or more users 182.

At any given time the enterprise 180 has, or is, pursuing commercial relationships with one or more external entities, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. Typically, each account 190 will have an associated set of individual contacts, referred to in this disclosure as “contacts” 192. For example, the individual contacts 192 associated with an account 190 may be employees, owners, partners, consultants, volunteers, and interns of the account 190. Furthermore, at any given time the enterprise 180 will typically have completed or will be pursuing one or more opportunities 194(1) to 194(k) (with k being account dependent and representing a total number of open and closed opportunities with a specific accounts). In this disclosure, the reference “opportunity 194(j)” will be used to refer a generic individual opportunity, and “opportunities 194” used to refer to a generic group of opportunities. An opportunity 194(j) may for example be a sales opportunity to sell a product or service, and may have an opportunity lifetime (e.g., duration of time from recognition of existence of the opportunity to closing of the opportunity) that can be divided into a set of successive stages or steps such as the seven basic stages of a sales cycle (e.g., Prospecting, Preparation, Approach, Presentation, Handling objections, Closing).

Enterprise network 110 may, for example, include a plurality of computer devices, servers and systems that are associated with the enterprise 180 and are linked to each other through one or more internal or external communication networks, at least some of which may implement one or more virtual private networks (VPN).

In example embodiments, the environment of FIG. 1 also includes a CRM support system 120 and a CRM system 200, each of which may also include one or more computer devices, servers and systems. One or both of CRM support system 120 and CRM system 200 may, in some examples, be operated by third party organizations that are service providers to the enterprise 180 associated with enterprise network 110. CRM support system 120 and a CRM system 200 are configured to track customer data on behalf of enterprise 180.

In the illustrated example, enterprise network 110, CRM support system 120, and CRM system 200 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, CRM support system 120, and CRM system 200. In different example embodiments, one or more of the features or functions of CRM support system 120 and CRM system 200 that are described herein could be alternatively be implemented in a common system or implemented within the enterprise network 110.

Enterprise network 110 includes at least one mail server 112 for handling and delivering external email that enterprise network 110 exchanges with remote mail servers through communication network 150. Thus, mail server 112 contains emails sent/received by the enterprise associated with enterprise network 110. In some examples, mail server 112 may also handle internal emails that are internal within enterprise network 110.

In example embodiments, enterprise network 110 includes a CRM agent 119 that provides the enterprise network 110 with an interface to CRM system 200.

In example embodiments, enterprise network 110 also includes a CRM support agent 114 that provides the enterprise network 110 with an interface to CRM support system 120. In example embodiments, CRM support agent 114 includes a connector 114 and a recommender 118. As described in greater detail below, connector 114 is configured to interact with systems within the enterprise network 110 (such as mail server 112) to extract information about activities (such as communication activities) and provide that information to CRM support system 120. As will also be described in greater detail below, recommender 118 is configured to interact with a user 182 to provide, among other things, intelligent information about how an opportunity is progressing and recommended next best actions.

In example embodiments, CRM system 200 may be implemented using a known CRM solution such as, but not limited to, Salesforce.com™, Microsoft Dynamics™, InterAction™ or Maximizer™, and includes a CRM database 170 that includes customer data (e.g., CRM data) for accounts 190 is desirous of tracking. The CRM data that is stored in a CRM database 170 for an account 190 may for example include: (I) general account data, (II) opportunity data about specific opportunities that the enterprise has undertaken in the past, is currently undertaking, or is proposing to undertake in the future with the account 190, and (III) individual contact data that includes contact information for individual contacts who are members of the account 190.

In example embodiments, CRM support system 120 is configured to provide enhanced CRM information and functionality that supplements CRM System 200. CRM support system 120 includes a relationship data storage 100 for storing relationship data generated in respect of the accounts 190 of interest to enterprise 180. In example embodiments, similar to CRM database 170, relationship data storage 100 may store, in respect of each account 190, relationship data objects 101 that include: (I) account data 102 that provide general information about the account 190, (II) opportunity data 104 about specific opportunities that the enterprise has undertaken in the past, is currently undertaking, or is proposing to undertake in the future with the account 190, (III) individual contact data 106 that includes contact information for individual contacts 192 (e.g., employees) who are associated with the account 190, (IV) user data 184, that includes information about enterprise users 182 who are involved in the relationship with an account 190, (V) user-contact relationship strength data 110, and (VI) activity data 184 that includes information about activities between enterprise 180 and account 190. The data in relationship data storage 100 may include some or all of the information stored at CRM database 170, as well as supplemental information.

Basic Data Acquisition and Tracking

In example embodiments, the collection and updating of basic account data stored in relationship data storage 100 is facilitated by a data tracking module 122 of the CRM Support System 120 that interfaces with the connector 116 of CRM support agent 114 and other possible data sources. In some examples, the data tracking module 122 of CRM support system 300 is configured to periodically refresh (e.g., for example on a timed cycle such an once every 24 hours) the content of data objects 101 such that the data maintained in relationship data storage 100 always includes current or near-current information. The data tracking module 122 may periodically refresh the information stored in relationship data storage 100 based on information from a plurality of sources. For example, CRM support system 120 may obtain data from the CRM database 170 of CRM system 200, from enterprise network 110, from one or more third party data provider database(s) 280, as well as from other data sources that are available through communication network 150.

In example embodiments, the basic data included in account data 102 stored at relationship data storage 100 may include, for an account 190, some or all of the fields listed in the following Table 1, among other things:

TABLE 1
Account Data Fields:

| Field | Field Description |
|---|---|
| Enterprise ID | Unique identifier assigned to Enterprise |
| | 180 |
| Account ID | Unique identifier assigned to Account |
| | 190 |
| Account Industry Code | Code that identifies primary industry |
| | type of customer organization (e.g., |
| | Standard Industrial Classification (SIC) |
| | Code and/or North American Industry |
| | Classification System (NAICS) Codes) |
| Number of Employees | Number of Employees of Account |
| | Organization |
| Account Size Score | Score assigned based on size of |
| | account organization (e.g., organization |
| | size of 1500+ = 10 points; 1000 to |
| | 1500 = 9 points; 750-1000 = 8 points, |
| | etc.). |
| Account Annual Revenue | Annual Revenue of account |
| | organization for one or more previous |
| | years |
| Owner User ID | User ID of enterprise user 182 who |
| | owns the account (e.g., user 182 who |
| | has primary responsibility for |
| | enterprise-account relationship) |
| Name | Name of Account ( e.g., company |
| | name) |
| Account Active Indicator | Indicates that Account is currently |
| | active |

In example embodiments, the basic data included in opportunity data 104 stored at relationship data storage 100 may include, for each opportunity with account 190, opportunity records that include some or all of the fields listed in the following Table 2:

TABLE 2
Opportunity Data Fields:

| Field | Field Description |
|---|---|
| Opportunity ID | Unique identifier assigned to |
| | Opportunity |
| Account ID | Account ID of the account that is the |
| | target of the opportunity |
| Created Date | Date opportunity registered with CRM |
| | support system |
| Closed Indicator | Indicates if opportunity is closed |
| Closed Date | Date Opportunity was closed |
| Won Indicator | Indicates opportunity closed |
| | successfully (e.g., with a sale) |
| Stage Indicator | Indicates stage that opportunity is at. |
| (Start Date, End Date)* | Can also include subfields for stage |
| | start and end dates (e.g., stages can |
| | be selected from the seven basic stages |
| | of the sales cycle) |
| Opportunity Type | Indicates type of opportunity (e.g., |
| | sale, lease, license) |
| Deal Quantity | Number of units expected to be |
| | sold/licensed |
| Deal Size Score | Score assigned based on estimated |
| | revenue (e.g., projected sales over |
| | duration of successfully closed |
| | opportunity: $1-$20,000 = 1 point; |
| | $20,001-$50,000 = 2 points; $50,001- |
| | $100,000 = 3 points; etc.) |
| Opportunity Duration | Expected lifetime of successfully closed |
| | opportunity (e.g., length of contract) |
| Geographic Indicator | Primary region of opportunity (e.g., NA, |
| | EMA, APAC, LATAM, SA) |
| Probability Indicator | Indicates a predicted likelihood of a |
| | successful close |
| Lead Source | Source of lead that generated |
| | opportunity (e.g., trade show inquiry; |
| | referral, etc.) |
| Main Contact ID | Contact ID of lead contact for |
| | opportunity with the account |
| Main User ID | Contact ID of lead user for opportunity |
| Last Activity Date | Date of most recent activity recorded in |
| | respect of opportunity |

*Indicates fields that will be repeated as required

In example embodiments, the basic data included in contact data 106 stored at relationship data storage 100 may include, for each contact 192 at account 190, contact records that include some or all of the fields listed in the following Table 3, among other things:

TABLE 3
Contact Data Fields:

| Field | Field Description |
|---|---|
| Contact ID | Unique contact identifier |
| Date Created | Date contact added |
| Account ID | Account ID of the account the contact is |
| | associated with |
| Department | Name of contact's department in the |
| | account organization |
| Title | Title/position of contact within account |
| | organization |
| Title Score | Score assigned to Contact based on |
| | contact's position at the account |
| | organization |
| Opportunity ID (*) | Opportunity ID for opportunity for |
| | which contact is member of the account |
| | team (e.g., purchasing team) |
| Opportunity Join Date (*) | Date that contact joined the account |
| | team for opportunity |
| Opportunity Left Date (*) | Date that contact left the account team |
| | for opportunity |
| First Name | Contact's First Name |
| Last Name | Contact's Last Name |
| Full Name | Contact's Full Name |
| Primary Email | Contact's Primary Email |
| Primary Phone | Contact's Primary Phone |

(*) Indicates fields that will be repeated as required (e.g. contact 192 can be involved in multiple opportunities)

In example embodiments, the basic data included in user data 108 stored at relationship data storage 100 may include, for each user 182 that has a relationship with a contact 192 at the account 190, user records that include some or all of the variable fields listed in the following Table 4, among other things:

TABLE 4
User Data Fields:

| Field | Field Description |
|---|---|
| User ID | Unique user identifier |
| Account ID | Account ID of the subject account |
| Department | Name of user's department in the |
| | enterprise organization |
| Title | Title/position of user within enterprise |
| | organization |
| Opportunity ID (*) | Opportunity ID for opportunity for |
| | which user is member of the enterprise |
| | team (e.g., selling team) |
| Opportunity Join Date (*) | Date that user joined the selling team |
| | for opportunity |
| Opportunity Left Date (*) | Date that user left the selling team for |
| | opportunity |
| Opportunity Role Indicator(*) | Numeric value that maps to role that |
| | user played in opportunity (e.g., lead, |
| | support, etc.) |

(*) Indicates fields that will be repeated as required (e.g. user 182 can be involved in multiple opportunities)

In example embodiments, the basic data included in user-contact relationship data 110 stored at relationship data storage 100 may include, for each user-contact relationship that exists between a user 182 within enterprise 180 and a contact 192 within the account 190, user-contact relationship records that include some or all of the variable fields listed in the following Table 5, among other things:

TABLE 5
User-Contact Relationship Data Fields:

| Field | Field Description |
|---|---|
| User ID | Unique user identifier |
| Contact ID | Contact Unique Identifier |
| Start Date | Date when relationship between user |
| | and contact started |
| Active Indicator | Indicates if relationship is currently |
| | active |
| Last Activity Date | Date of last recorded activity including |
| | user and contact |

In example embodiments, the activity data 112 stored at relationship data storage 100 may include data for activities are related to the entity-account relationship. Activities may for example include communication activities and documentation activities among other things. Activity data 112 may include respective activity records (AR) 113 for each logged activity. Each activity record 113 may include, depending on the type of activity and availability of information, the variable fields listed in the following Table 6, among other things:

TABLE 6
Activity Data Fields:

| Field | Field Description |
|---|---|
| Activity ID | Unique identifier assigned to activity |
| Account ID | Identity of Account whose contacts |
| | participated in the activity |
| Opportunity ID | Identity of the opportunity that activity |
| | related to |
| Activity Type Indicator | Value that identifies the type of activity |
| | (e.g., (i) communication activity: |
| | incoming email, outgoing email, |
| | incoming meeting request, outgoing |
| | meeting request, incoming phone call, |
| | outgoing phone call, in-person meeting, |
| | virtual meeting, (ii) documentation |
| | activity: proposal submitted, draft |
| | statement of work (SOW) submitted; |
| | final SOW submitted; contract |
| | submitted for review). |
| Document ID | ID of document template (can be used |
| | to identify content of standard form |
| | email in the form of a communication |
| | action, or to identify document |
| | template in case of documentation |
| | activity) |
| Start Time | Date and time stamp indicating start of |
| | activity |
| Activity Duration | Duration of activity (e.g., length of |
| | meeting or phone call) |
| Sentiment Indicator | Indicator provided manually or by |
| | natural language processing algorithm |
| | as to sentiment of activity (e.g.: |
| | negative to positive sentiment on scale |
| | of 1 to 5, in example embodiments, |
| | may be determined at CRM support |
| | agent 114 and sent by connector 116 |
| | to data tracking module 122) |
| Content Count* | Counts number of occurrences of |
| | predefined words in communication |
| | activity (e.g., product name, competitor |
| | product name). (In example |
| | embodiments, may be determined at |
| | CRM support agent 114 and sent by |
| | connector 116 to data tracking module |
| | 122) |
| Participants-Account* | Contact IDs or other available identifier |
| | for all parties involved on account side |
| | of activity |
| Participants-Enterprise* | User IDs or other available identifier for |
| | all parties involved on enterprise side of |
| | activity |

*Indicates fields that will be repeated as required

In example embodiments, the data variables included in the fields of Tables 1 to 5 above will generally be static information (e.g. information that is expected to stay reasonably constant over time) imported from a data source (e.g., CRM system 200 or third party data provider database 280), and/or derived from pre-defined look-up-tables (LUTs) based on the provided or imported data (e.g., “title score” derived from defined LUT based on contact's title). In example embodiments, the CRM support system 120 is configured to log and record changes that occur in one or more of the variable fields so that changes in data can be tracked over time. Activity data is inherently dynamic as new activity records 113 are continuously generated in respect of an opportunity. Some of the dynamic data (e.g., information that is expected to change frequently over time) in Tables 1 to 5 may be obtained from activity records that correspond to Table 6—Activity Data, including for example “Last Activity Date” in Tables 1 and 5.

In example embodiments, at some of the activity records 113, such as activity records generated in respect of communication activities, included in activity data 112, are generated and at least partially populated based on information generated through automated tracking of electronic events that occur at enterprise network 110. Some activity records 113, such as activity records generated in respect of document events, may in at least some example be generated in response to information provided by a user 182 through an interface supported by CRM support agent 114, which is then relayed to CRM support system through communication network 150.

Regarding activity data 112, in example embodiments, connecter 116 is configured to automatically collect information about communication activities between users 182 associated with the enterprise 180 and external contacts 192 associated with an account 190. These communication activities may for example be electronic communications such as email, meetings that are tracked in calendar systems and/or scheduled through email communications, and telephone calls that occur through a system that enables call logging. Each of these interactions have associated electronic data that includes a contact identifier (e.g., email address or phone number for contact 192), time stamp information for the interaction, and a user identifier (e.g., data that identifies the member(s) 182 of the enterprise 180 that were involved in the interaction.

In example embodiments, connecter 116 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the data tracking module 122.

In some examples, the connector 116 is configured to extract selected information from email messages as contact interaction data 310. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC recipient.

In some example embodiments, the extracted information could include additional information from the email such as contact information embedded in the email body, and in this regard, a data scrapping function such as that described in U.S. patent application Ser. No. 16/907,998 filed Jun. 22, 2020, entitled “System and Method for Identifying and Retrieving Signature Contact Information from an Email or Email Thread”, incorporated herein by reference, may be applied to retrieve such information. For example, such a system may also extract additional contact information such as name, title, phone number, social media links, and company name from an email message, for inclusion as part of the contact interaction data 310 (e.g., as “other” data in the example of FIG. 3).

In example embodiments, meeting requests and invites will be included among the email messages that are processed by mail server 112, and connector 116 is configured to include email addresses in the meeting invitee list and organizer fields in the contact interaction data 310 extracted from the emailed meeting invite. In some examples, connector 116 may also be configured to communicate directly with calendar applications of users 182 within the enterprise network 110 to identify email addresses belonging to possible external contacts, and include that information in communication activity data. In some examples where enterprise network 110 supports phone call logging, for example in Voice-Over-Internet-Protocol (VOIP) implementations, connector 116 may be further configured to interact with a VOIP server to collect information about external phone numbers used for outgoing and internal calls for inclusion in communication activity data.

Pattern Generation

In example embodiments, CRM support system 120 includes a computer implemented pattern generation module 124 that is configured to perform a number of functions and processes in respect of the basic data collected and stored at relationship data storage 100 to extract further analytical information about accounts 190, opportunities 194, contacts 192 and users 180.

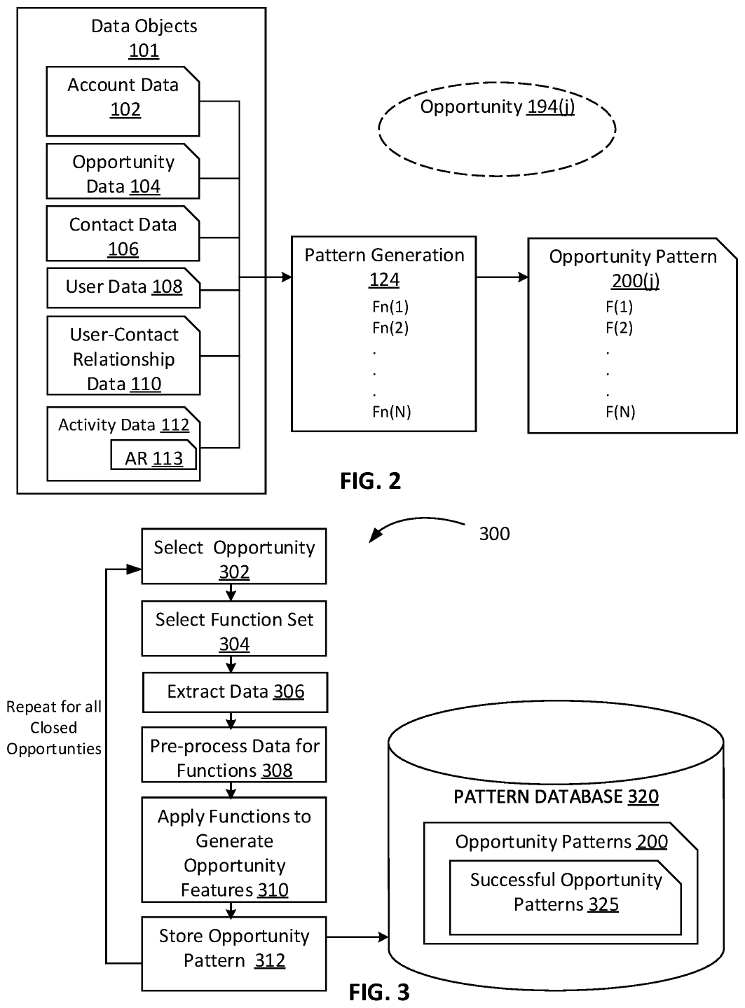

Referring to FIG. 2, in an example embodiment, pattern generation module 124 is configured to generate a respective opportunity pattern 200(j) for a specific opportunity 194(j) based on the basic data included in data objects 101. In example embodiments, an opportunity pattern 200(j) is defined by a set of pattern features F(1) to F(N) that quantitatively represent a specific opportunity 194(j) (e.g., N equals the number of pattern features that define an opportunity pattern 200(j), opportunity pattern 200(j)=(F(1), . . . , F(N)). “Patterns 200” will be used hereinafter to generically refer to a group of opportunity patterns. In example embodiments, some of the pattern features F(1) to F(N) may be single value scalers, and some of the pattern features F(1) to F(N) may be multi-dimensional tensors. Each pattern feature F(1) to F(N) is a different type of feature that numerically represents a unique property or set of properties of the opportunity 194(j).

In example embodiments, the pattern generation module 124 is preconfigured with a set of respective functions fn(1) to fn(2) for generating the respective pattern features F(1) to F(N). Each function fn(i) (where fn(i) represents a generic function, 1≤i≤N) is configured to map a defined set of variables extracted from the data objects 101 to a respective pattern feature F(i). In example embodiments, the functions fn(1) to fn(N) and their respective sets of input variable types and output feature types are predetermined based on analysis of data objects 101 pertaining to several historical opportunities. In some examples, such analysis include statistical analysis methods, such as for example principle component analysis, performed based on historic opportunity data using iterative simulation, modeling and analysis techniques. In some examples, the set of functions fn(1) to fn(N) may include deterministic functions that combine variables according to predetermined rules, machine learning based functions that have been trained to implement a non-linear prediction model, or a combinations of both. In the case of a pattern feature F(i) that is single value scaler, the respective function fn(i) may be configured to apply respective predetermined weight values to input variables, and then use a mathematical operator to combine the resulting weighted variable values. For example, the weighted variable values could be summed together, with the respective weight values each representing a relative contribution of the respective input variables as determined through statistical analysis methods such as principle component analysis.

In some example embodiments, pattern generation module 124 may be configured to apply the same set of functions fn(1) to fn(N) in respect of all opportunities 194 for all types of accounts industry types and sizes for all enterprises. However, pattern generation module 124 may be configured to apply tailored sets of functions to different specific opportunity scenarios. For example, respective sets of functions may be preconfigured that are customized based on one or more of the following variable categories: enterprise ID, account ID, industry code, account size score, account annual revenue, opportunity type, deal quantity, deal size score, and/or geographic indicator. In at least some examples, a generic set of functions may be applied until a threshold amount of data exists for closed opportunities to permit a more specific set of functions to be configured and applied. By way of example, once a particular enterprise 180 has completed a sufficient number of opportunities, it may be possible to develop a set of functions fn(1) to fn(N) that are based primarily on analysis of the historical data for that particular enterprise 190. In a further example, for an enterprise without a large enough set of historical data, a function set designed for a specific industry based on analysis of anonymized historical information for that specific industry (e.g., accounting firms) could be used.

Configuration—Generation of Patterns for Historic Opportunities

Referring to FIG. 3, in example embodiments CRM support system 120 is configured to perform a configuration process 300 during which pattern generation module 124 is used to generate an initial set of opportunity patterns 200 for a pattern database 320 that may be stored in relationship data storage 100. As indicated in block 302, the process begins with selection of a closed opportunity 194(i) from the opportunities identified in the opportunity data 104 associated with enterprise 180.

As indicated in block 304, a set of functions fn(1) to fn(N) is selected for processing the closed opportunity. As noted above, the set of functions fn(1) to fn(N) may be generic for all opportunities in which case the selection block 304 is not required. However as noted above, in some examples, one or more functions may be customized, in which case the set of functions that is selected may depend on one or more of the following variables that can be associated with a specific opportunity: enterprise ID, account ID, industry code, account size score, account annual revenue, opportunity type, deal quantity, deal size score, and/or geographic indicator, among other things.

As indicated in block 306, the data required as input to the set of functions fn(1) to fn(N) is then extracted from the data stored in data objects 101 relating to the selected opportunity. As indicated in block 308, the extracted data is preprocessed as required. This may for example include conventional preprocessing operations such as: inferring missing data, removing or otherwise dealing with outliers, standardizing (e.g., scaling) and normalizing data, and aggregating data over a time period, converting qualitative or categorical variables to quantitative numerical values, among other things.

The set of functions fn(1) to fn(N) are applied to the pre-processed input data to generate respective opportunity features F(1) to F(N), as indicated in block 310.

The resulting set of opportunity features F(1) to F(N) is the opportunity pattern 200(j) for closed opportunity 194(j), and is stored in pattern database 320. The opportunity pattern 200(i) is stored with metadata that provides a creation timestamp and identifies the opportunity ID, account ID and enterprise ID associated with the closed opportunity 194(j), as well as a Won Indicator for the closed opportunity 194(j) in the event that the closed opportunity 194(j) had a successful outcome. The opportunity patterns 200 that are tagged with a Won Indicator collectively form a set of “Successful Opportunity Patterns 325”.

During configuration mode, the operations represented by blocks 302 to 312 of process 300 can be repeated for several closed opportunities 194, resulting in a set of discrete opportunity patterns 200, each of which corresponds to a respective closed opportunity 194, being stored in pattern database 320.

In example embodiments, after an initial configuration to build the initial content for pattern database 320, operations represented by blocks 302 to 312 can be performed in respect of newly closed opportunities as they are closed, such that the pattern database 320 is continuously augmented with new opportunity patterns 200. In some examples, older opportunity patterns 200 that fall outside of an age threshold may occasionally be archived and removed from pattern database 320.

In some examples, the operator of CRM support system 120 may periodically revaluate the opportunity functions fn(1) to fn(N) to determine if any of the functions fn(1) to fn(N) should be updated. In the event that a decision is made to update the opportunity functions fn(1) to fn(N), the configuration process 300 can be rerun on the historic opportunity data included in data objects 101 to develop a new set of opportunity patterns 200 for future use.

### Opportunity Feature Examples

An illustrative, but non-limiting, example of the categories and types of possible opportunity features F(1) to F(N) that may be generated by pattern generation module 124 for inclusion in an opportunity pattern 200(j) will now be described. The list provided below is not comprehensive and in may be applied in different configurations and combinations in different example embodiments. In some examples, some features described below may be omitted from a pattern, and in other cases features other than those described below may be included in a pattern.

(I) Static Opportunity Features

In an example embodiment, one category of features are static opportunity features. The pattern generation module 124 is configured to apply one or more functions based on static input variables to generate one or more respective static opportunity features. Static refers to variables and features that will typically be expected to remain constant over the lifetime of an opportunity 194(j). Examples of types of possible static features include:

(I.i) Comprehensive Static Opportunity (“CSO”) Feature: in example embodiments, a Comprehensive Static Opportunity (“CSO”) Function is configured to assemble a multidimensional CSO feature vector that comprises the listed static variables as attributes:

CSO Feature=(Industry Code, Account Size Score, Account Annual Revenue, Opportunity Type, Deal Quantity, Deal Size Score, Lead Source, Geographic Region)

In the illustrated example, the CSO Feature is an eight-dimensional feature vector that is made up of attributes that are directly derived from variables that are included in the basic tracked data listed above in Tables 1 and 2. In example embodiments, the variables are quantified (if the original variable is categorical) and standardized according to predetermined criteria during preprocessing (block 308), and in the CSO function applied in block 310 simply assembles the pre-processed variables as respective attributes into a multi-dimensional vector that forms the CSO feature.

In alternative example embodiments, at least some of the variables identified may be omitted from the CSO Feature, and in other examples, additional variables could be added.

(I.ii) Unified Static Opportunity (“USO”) Feature: in example embodiments, a Unified Static Opportunity (“USO”) Function is configured to generate a scaler USO Feature that is a single value derived from the attributes identified above in respect of CSO Feature, namely: Industry Code, Account Size Score, Account Annual Revenue, Opportunity Type, Deal Quantity, Deal Size Score, Lead Source, and Geographic Region. In an example embodiment the USO Function is configured to aggregate these attributes by applying respective predetermined weights to each attribute and summing the resulting weighted values together. In some examples, the USO function could be derived from a smaller set of attributes including for example Industry Code, Account Size Score, Account Annual Revenue, Opportunity Type.

(I.iii) Deal Importance Feature: in example embodiments, a scaler Deal Importance Feature that represents a perceived importance of a deal is determined by a respective deal importance function. In example embodiment, the deal importance function may be a composed from the static variables: Deal Quantity, Deal Size Score and Deal Duration. The deal importance function may be configured to combine the three variables, weighted with respective predetermined weights, using a mathematical operator (e.g., multiplication) to generate a single scaler value as the Deal Importance Feature.

(I.iv) Account Importance Feature: in example embodiments, a scaler Account Importance Feature that represents a perceived importance of the account 190 is determined by a respective account importance function. In example embodiment, the account importance function may be a composed from the static variables: Account Size Score and Account Annual Revenue. The account importance function may be configured to combine these variables, weighted with respective predetermined weights, using a mathematical operator (e.g., multiplication) to generate a single scaler value as the Account Importance Feature.

(I.v) Industry Feature: in example embodiments, a scaler Industry Feature is determined to represent the industrial sector that the opportunity pertains to. In some examples embodiments, the Industry Feature directly corresponds to the Account Industry Code.

(I.vi) Merged Static Opportunity (MSO) Feature: in example embodiments, selected composite and scaler features may be combined to form further features. For example, in example embodiments, the scaler Deal Importance, Account Importance and Industry features could be assembled by an MSO function to generate a respective multidimensional MSO feature that comprises the attributes:
MSO Feature=(Deal Importance Feature, Account Importance Feature, Industry Feature)

In the illustrated example, the MSO Feature is a three-dimensional feature vector that may require less computing power for subsequent processing than the CSO Feature described above.

(II) Dynamic Opportunity Features

A further category of features is dynamic opportunity features. In an example embodiment, the pattern generation module 124 is configured to apply one or more functions based on a dynamic input variables to generate one or more respective dynamic opportunity features. Dynamic refers to variables and features that change over the lifetime of an opportunity 194(j). In some examples, dynamic features represent the state of an opportunity at a given time period. In example embodiments, different time period versions of the same dynamic opportunity feature may be calculated and saved as part of the opportunity pattern 200(j), with each version representing a respective state of an opportunity 194(j) at different times of the opportunity. For example, the opportunity pattern 200(j) for an opportunity 194(j) may include seven versions of the same dynamic opportunity feature, each version representing a state at a different stage of the seven sales cycle stages. In example embodiments, dynamic opportunity features could be determined for time periods that don't correspond to sales cycle stages, for example successive weekly time periods. In some examples, different sets of a dynamic opportunity feature could be included in a opportunity pattern 200(j), for example a first set in which the dynamic opportunity features are determined in respect of weekly periods, a second set in which the dynamic opportunity features are determined in respect of monthly periods, and a third set determined in respect of time periods that correspond to sales cycle stages.

Examples of different types of possible dynamic features that may be generated for time periods (for examples, time periods associated with the stages of an opportunity) include:

(II.i) Communication Activity Feature: in example embodiments, a communication activity function is configured to assemble a multidimensional communication activity feature that is representative of frequency and direction of communications between the enterprise 182 and account 190 for each stage of an opportunity 194(i). For example, the Communication Frequency Feature for a specific stage (as identified by Stage Indicator) of opportunity 194(i) could include some of the following attributes listed in Table 7.

TABLE 7
Communication Activity Feature Attributes (per stage):

| Field | Field Description |
|---|---|
| Incoming Emails | Average number of weekly incoming |
| | emails (e.g., from Account to |
| | Enterprise). |
| Outgoing Emails | Average number of weekly outgoing |
| | emails (e.g. from Enterprise to |
| | Account). |
| Ratio of Incoming to | Based on above two attributes |
| Outgoing Emails | |
| Email Response Time- | Average Time to respond to incoming |
| Enterprise | email from Account |
| Email Response Time- | Average Time for Account to respond to |
| Account | email from Enterprise |
| Number of Virtual | Average number of weekly meetings |
| Meetings | with Enterprise by phone or video |
| | conference |
| Number of In-Person | Average number of weekly meetings |
| Meetings | with Enterprise in-person |
| Meeting Duration | Average duration of meetings with |
| | Enterprise |
| Participants Score- | Average Sum of the Title Scores of all |
| Account | Account Contacts that participated in |
| | communication activities (e.g., attribute |
| | is indicative of seniority) (May be done |
| | as average for all communication |
| | activities, or include attributes for each |
| | communication activity type, or both) |
| Number of Participants- | Average number of contacts that |
| Account | participated in communication |
| | activities. (may be done as average for |
| | all communication activities, or include |
| | attributes for each communication |
| | activity type, or both) |

As can be seen above, Communication Activity Feature can include attributes that indicate frequency of different types of communications activities within a stage, and the seniority and number of people involved in such activities.

Referring to FIG. 3, the data required for the attributes listed in Table 7 may be derived by extracting the relevant information from data objects 101 (block 306) and then preprocessed (block 308) to aggregate and standardize the data as required. The communication activity function applied in block 310 simply assembles the pre-processed variables as respective attributes into a multi-dimensional vector that forms the Communication Activity Feature.

(II.ii) Communication Velocity Feature: in example embodiments, a communication velocity function is configured to reduce the multi-dimensional Communication Activity Feature to a single scaler value that is representative of a communication velocity for the respective stage of the opportunity 194(i). In an example embodiment the communication velocity function is configured to aggregate the attributes of Table 7 by applying respective predetermined weights to each attribute and summing the resulting weighted values together.

(II.iii) Enterprise and Account and Team Membership Features: in example embodiments, and Enterprise Team Membership Feature and an Account Team Membership Feature may be generated for each stage of the opportunity. By way of example, an Enterprise Team Membership Feature could be generated by a function that outputs a multidimensional feature vector that includes as attributes the user IDs of the enterprise users 182 who are members of the sell team during that stage, based on data extracted from data objects 101. Similarly, an Account Team Membership Feature could be generated by a function that outputs a multidimensional feature vector that includes as attributes the contact IDs of the account contacts 192 who are members of the buy team during that stage, based on data extracted from data objects 101. In some examples, the department ID's of the involved team members may also be included as attributes in the respective Enterprise Team Membership and Account Team Membership Features or in a separate Department Involvement Feature

(II.iv) Team Relationship Strength Feature: in example embodiments, a Team Strength Relationship Feature for a stage that represents an overall strength of the relationships between the teams may be generated by a respective function based on the team members identified in the Enterprise Team Membership and Account Team Membership Features. In an example embodiment the Team Strength Relationship Feature may be a scaler value based on a combination of title scores of the team members and the perceived relationship strengths of the individual user-contact relationships within the team relationship. For example, in one embodiment the Team Strength Relationship Feature may be based on a sum of all of the User-Contact Relationship (“UCR”) scores (described below) for all user-contact pair combinations that are included among the members participating in the opportunity 194(i).

(II.v) Deal Momentum Feature: In example embodiments, a pre-defined function is applied to combine the Communication Velocity Feature and the Team Relationship Feature determined in respect of a stage to generate a Deal Momentum Feature.

(II.vi) Communication Content Quality Feature: In example embodiments, the Sentiment Indicators and Content Counts (see Table 6 above) collected in respect of communication activities over a stage are processed by a respective predefined function to generate a Communication Content Quality Feature that is a scaler value representative the content of communications between the teams.

(II.vii) Documentation Activity Feature: in example embodiments, a documentation activity feature may be generated that is a multidimensional feature that indicates the Document IDs for any document exchanged during the stage. In some examples, such a feature may be used to determine in future analysis the impact that a particular document template had on the success of an opportunity.

(II.viii) Enterprise-Account Relationship Features

In example embodiments, as a sub-category of dynamic features, pattern generation module 124 is configured to determine a set of relationship features that pertain to the larger overall enterprise-account relationship during the stages of an opportunity. Illustrative examples of types of possible relationship features are as follows.

(i) User-Contact Communication (“UCC”) score: a scaler feature that represents a perceived strength of communication activities between an individual user 182 and an individual contact 192. The UCC score is determined by using a predetermined UCC function to map features relating to historical communication activities history between the user and contact to a respective UCC score. For example, a UCC score could based on features such as, among other things: activity type indicator (e.g. value that identifies the type of activity into categories such as: incoming email, outgoing email, incoming meeting request, outgoing meeting request, incoming phone call, outgoing phone call, in-person meeting, on-line meeting, video conference); frequency (e.g., number of communication activities with a defined time period); recentness of communication activities; length of communication activity; and sentiment of communication activity. For example, an UCC score could be quantified as a percentage (e.g., 0 to 100%) by applying the predetermined UCC function, which may in some example be a deterministic linear rules-based model, and in other examples may be a trained non-linear predictive model. In example embodiments, a deterministic model may be derived a data scientist based analysis of simulated data and real data using one or more statistical analysis methods.

(ii) User-Contact Relationship (“UCR”) score: a scaler feature indicating a perceived value of the relationship between an individual user 182 and an individual contact 192, and may for example be based on a combination of the contact's position and the UCC score for the relations, as represented by the following function for example: UCR score=(Contact's Title Score)*(UCC score).

(iii) Total User-Account Relationship (“TUAR”) score: a scaler feature indicating the perceived overall relationship strength of an individual user 182 with the account 190. Such value for example may be based on a sum of all of the UCR scores an individual 182 has with contacts 192 from the account 190. This value can be used for example to identify the user 182 at enterprise 180 who has the strongest relationship with the account 190.

(iv) Total Enterprise-Account Relationship (“TEAR”) score: a scaler feature indicating a perceived overall relationship between the enterprise 180 and the account 190. Such value for example may be based on a sum of all of the individual TUAR scores for individuals 182 of enterprise 182 who have contacts within the account 190.

(v) Total User Relationship (“TUR”) score: a scaler feature indicating the perceived overall rating of the entire contact network for an individual user 182, spanning all organizations that are respective accounts 190 of the enterprise. Such value for example may be based on a perceived importance of each account 192 as represented by the Size Score assigned to each account 190, the position of the contacts 192 that the user 182 has relationships with, and the UCC scores in respect of such relationship. For example, a TUR score for a user 182 could be determined as follows: (a) For each user-contact relationship, determine the product of: (Size Score)*(Title Score)*UCC score; (b) sum all of the products determined to get TUR score.

By way of further context, an example of a system and method for determining relationship strength data is disclosed in U.S. Pat. No. 9,633,057, issued Apr. 25, 2017, the contents of which are incorporated herein by reference.

(III) Milestone Opportunity Features

A sub-category of dynamic features includes milestone opportunity features. In an example embodiment, the pattern generation module 124 is configured to apply one or more pre-defined functions to generate different types of Milestone opportunity features that are based on a combination of static opportunity features and dynamic opportunity features described above. Milestone Features identify the timing of a key event or activity during the lifetime of an opportunity 194(j). Accordingly, in example embodiments, pattern generation module 124 applied one or more functions that look at one or more of activity data 112 generated in respect of an opportunity 194(j), static opportunity features generated in respect of that opportunity 194(j), and/or dynamic opportunity features generated in respect of that opportunity 194(j) to determine if and when a milestone events has occurred during the duration opportunity and the time of the occurrence.

For example, a Team Transition Milestone could correspond to a team transition event that can be detected by comparing the Dynamic Enterprise and Account and Team Membership Features noted above to detect when a different department becomes involved. For example, a change in Account team membership to include members of the legal department may represent a milestone, and the occurrence and timing of that milestone can be tracked as a milestone feature that becomes part of the opportunity pattern 200(j).

Another possible milestone event type could include a document exchange event.

In some examples, milestone events may be based on detecting the occurrence of an inflection in the different values calculated for a dynamic opportunity feature during the opportunity. For example, a change in the Deal Momentum Feature over time that is beyond a threshold variation may be detected by a respective function as a milestone data inflection event. The occurrence and timing of the event may be recorded as a respective milestone feature that becomes part of the opportunity pattern 200(j). In some example's inflections in the Communication Velocity Feature over time may be detected and logged as a milestone feature.

Accordingly, it will be appreciated that the opportunity pattern 200(j) that is generated by pattern generation module 124 in respect of an opportunity 194(j) can include several different types of features falling within different feature categories, including static features, time-varying dynamic features, and milestone features. These features can collectively define an opportunity pattern 200(i) that the patterns generated in respect of other opportunities can be benchmarked and compared against. A plurality of opportunity patterns 200, including successful opportunity patterns 325 are stored in pattern database 320.

In some examples, the patterns for multiple successful opportunity patterns may be merged together to form a master pattern. For example, featured from a corresponding plurality of similar successful opportunity patterns for a specific product could be merged through an aggregating process to provide a master pattern for that product. The master pattern may then replace the corresponding plurality of similar successful opportunity patterns in pattern database 320. Such a configuration may be useful in embodiments where some of the functions and modules of CRM support system 126 are implemented on resource constrained computing devices.

Open Opportunity Advising

In example embodiments, CRM support system 120 is configured to use the historic opportunity patterns 200 stored in pattern database 320 to provide feedback and information to users 182 about ongoing opportunities. As noted above, in example embodiments, the CRM support agent may include recommender 118 that is configured to interact with a user 182 to provide, among other things, intelligent information about how an opportunity is progressing and recommended next best actions.

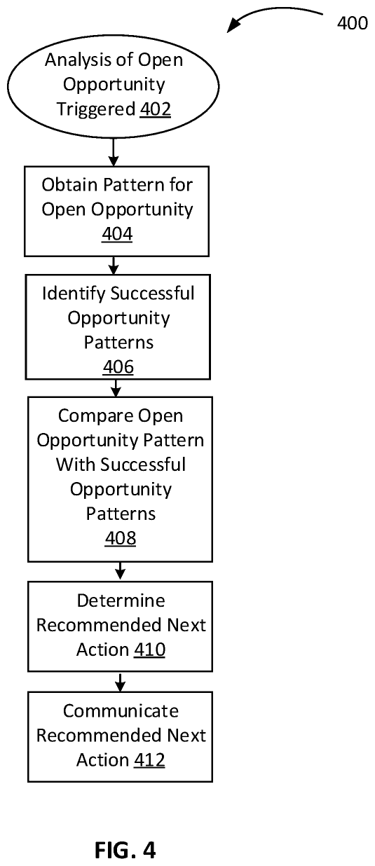

In this regard, in example embodiments, the CRM support system 120 includes a computer implemented next best action module 126 that is configured to cooperate with data tracking module 122 and pattern generation module 124 to generate feedback that can be provided through recommender 118 to a user 182 that is involved with an opportunity (e.g. an open opportunity 194(o)). FIG. 4 is a flow chart of representing a process 400 performed by next best action module 126 according to example embodiments.

As indicated at block 402, process 400 commences when a triggering event occurs that causes next best action module 126 to analyse a target or open opportunity (e.g., open opportunity 194(o)). In some examples, the process 400 could be triggered by a request entered through recommender 118 by a user 182. In some examples, the process 400 could be automatically triggered by data tracking module 122 recognizing an event relating to the open opportunity 194(o) and calling on next best action module 126 to perform an analysis of open opportunity 194(o). In some examples, the process 400 could be automatically triggered as part of a batch process in which a plurality of open opportunities are to be processed.

As indicated in block 404, next best action module 126 is configured to obtain a current opportunity pattern 200(o) for the open opportunity 194(o). In example embodiments, next best action module 126 either calls on pattern generation module 124 to perform the operations indicated in blocks 304 to 310 of process 300 (see FIG. 3) or alternatively performs such operations itself to obtain the current opportunity pattern 200(o). In particular, as indicated in block 304 a set of predetermined functions fn(1) to fn(N) are selected for generating the current opportunity pattern 200(o). In some examples, the set of functions fn(1) to fn(N) may be selected based on the type of opportunity or one or more other characteristics of the opportunity such a size or participating enterprise and/or account for example. The data required by the functions is then extracted (block 306) from data objects 101 relating to open opportunity 194(o) that have been recorded by data tracking module 122 or otherwise provided. The data is preprocessed as required (block 308), and then subjected to the set of predetermined functions fn(1) to fn(N) (block 310) to generate a respective set of opportunity features F(1) to F(N) that collectively represent the opportunity pattern 200(o) for open opportunity 194(o).

Referring again to FIG. 4, as indicated in block 406, the next best action module 126 is configured to compare one or more opportunity features of the opportunity pattern 200(o) for open opportunity 194(o) to features of the successful opportunity patterns 325 included in pattern database 320 to identify a set of successful opportunity patterns 325 that correspond to closed opportunities 194 that are similar to open opportunity 194(o).

In example embodiments, pre-filtering based on metadata may be performed such the comparison may be limited to successful opportunity patterns 325 that fall within a defined time period (e.g. last two years), or correspond to specific account IDs and/or enterprise IDs.

In an example embodiments, similar successful opportunity patterns 325 are determined based on a similarity of the static features. For example, as indicated above, the CSO Feature includes eight attributes=(Industry Code, Account Size Score, Account Annual Revenue, Opportunity Type, Deal Quantity, Deal Size Score, Lead Source, Geographic Region), enabling an opportunity to be presented as a point in an 8-dimensional feature space. In example embodiments, a k-nearest neighbor algorithm is used to identify the k successful opportunities that have the closest CSO Features to the CSO feature of the open opportunity 194(o).

The CSO feature is just one example of a feature that can be used as a measure of similarity. In other examples some dimensions from the CSO feature can be ignored when determining similarity, and in some examples lower dimensionality static features can alternatively be used, including for example the Unified Static Opportunity (“USO”) Function, which requires only a single dimension comparisons.

In some example embodiments, the selection of similar opportunities could be done in stages, with a first feature used to identify a first group of candidate successful opportunities that can then be further narrowed down by doing a further k-nearest neighbor selection based on a further feature.

In some examples, the set of similar successful opportunity patterns may include only 1 pattern.

As indicated in block 408, one or more of the features included in the open opportunity pattern are compared with corresponding features from the set of similar successful opportunity patterns to identify differences and similarities between the features. In example embodiments, such comparisons are based on different features than used in block 406 to identify similar opportunity patterns. For example, the comparisons performed in block 408 may be based on comparisons of one or more of the dynamic features identified above to determine difference that exist in the values between current open opportunity and the successful opportunities when they were at the same opportunity stage.

In some example embodiments, comparisons may also be made between milestone features.

In some examples, a comparison may be based on determining if the value of a feature or a feature attribute varies by more than a defined threshold from an average value determined in respect of the set of similar successful opportunity patterns. In some examples, the defined threshold could be a set value or percentage, and in some examples it may be based on a statistically based deviation. In other examples, other statistic based comparison methods may be used. In some example embodiments, the results of a comparison based on one feature may trigger an analysis based on a further higher dimensionality feature. For example, a preliminary comparison of the Deal Momentum Feature for the open opportunity 194(o) with the average of Deal Momentum Feature for the set of similar successful opportunity patterns may fall outside of a defined threshold, causing next best actual module 126 to then perform comparisons based on Communication Velocity Feature and Team Relationship Feature. In an illustrative example, such an analysis indicates that the Team Relationship Feature of the open opportunity 194(o) falls within an acceptable threshold range of an average determined in respect of the set of similar successful opportunity patterns, but that the Communication Velocity Feature is outside an acceptable threshold range. Accordingly, next best action module 126 then performs comparisons based on the attributes included in the Communication Activity Feature. As a result of such comparisons, next best action module 126 determines all of attributes compare favourably with the exception of the number of weekly meetings for the open opportunity 194(o), which is substantially lower than the number of weekly meetings determined in respect of the set of similar successful opportunity patterns that same stage in the opportunity.

By way of numeric example, in one embodiment two features that are considered are number of weekly outbound emails and weekly meetings, and the number patterns included in the comparison set of similar successful opportunity patterns is k=5. The opportunity is currently in stage 4. For the 5 successful opportunity patterns, the average number of outbound emails during stage 4 was: {18, 14, 16, 23, 23} and the average number of meetings was {9, 11, 11, 6, 15}. By comparison, so far in stage 4 for open opportunity 194(o) the average number of outbound emails during stage 4 has been {19} and the average number of meetings has been {2}. Based on comparing these features, the number of outgoing emails for open opportunity 194(o) is within an acceptable range, but the number of meetings is too low and falls outside an acceptable range.

In at least some example embodiments, the identification of unacceptable feature values in open opportunity 194(o) may be determined by a machine learning based function.

Accordingly, as indicated in block 408, based on the feature comparisons between the opportunity pattern of the open opportunity 194(o) and the set of similar successful opportunity patterns, a determination can be made if one or more features fall outside of acceptable ranges.

Next best action module 126 is configured to determine a recommended course of action based on the features that fall outside of acceptable ranges (block 410). For example, in the above example of too few meetings, the Next best action module 126 could be configured to determine that more meetings are required. As indicated in block 412, this next best action is communicated. In particular, in an example embodiment, next best action module 126 sends a message to CRM support agent 114, which in turn causes recommender 118 to output via a user interface output the message “Your number of meetings for this opportunity is too low for stage 4. Book additional meetings”.

As noted above, in example embodiments a set of features that are indicative of a relationship strength between enterprise and account and individual users—contacts are determined in example embodiments. In at least some examples in which a determination is made in block 408 that a feature for the open opportunity 194(o) that is not related to relationship strength falls outside an acceptable range (e.g. does not meet the pattern of success as represented by the set of similar successful opportunity patterns), next best action module 116 may be configured to determine if there is a corresponding impact on the relationship strength scores determined in respect of the open opportunity 194(o) and the set of similar successful opportunity patterns. In the event that one or more relationship scores for the open opportunity 194(o) compare favourably to those for the set of similar successful opportunity patterns, a determination may be made that corrective action is not required. Similarly, a negative comparison may indicate that more immediate action is required to be recommended.

Overview and Alternative Configurations

In some example embodiments, CRM support system may be configured to perform comparisons similar to that described in respect of FIG. 4 in respect of closed activities. For example, comparisons of features between opportunities that have closed successfully may allow unfavorable actions to be highlighted to they can be modified in the future. For example a comparison of the Document Activity Feature between opportunities may reveal that opportunities have a much greater chance of closing if one set of template documents is used instead of another set of documents.

In at least some examples, the described systems and methods may improve the efficiency and accuracy of performing comparative data analysis to generate action recommendations recommendation, thereby enabling one or more of the CRM system computing devices that make up the CRM support system 120, CRM system 200 and enterprise network 110 to expend fewer computing resources, consume less power and/or require fewer data and power consuming human interactions than might otherwise be required to achieve similar results in the absence of the disclosed systems and methods.

In the illustrated embodiment, next best action module 126 and data enhancement module 124 are hosted at enterprise network 110, and CRM support system 120 and CRM system 200 are remotely hosted outside of the enterprise network. In different embodiments, features and systems preformed at one system can be moved to a different system. For example, in alternative example embodiments, one or both of CRM support system 120 and CRM system 200 may be moved in their entirety to within the enterprise network 110. In some example embodiments, some or all of the functionality of CRM system 100 and CRM support system 120 may be merged into a single system.

Data objects 101 can be electronically stored in various database formats in different embodiments. In some examples, data objects 101 may include records stored as part of relational database. In some examples a record may be a virtual record that identifies or links to other data sources for the actual content of the feature field of that record. In some cases, feature fields of a record may include sub-records comprising multiple fields or links to such sub-records.

### Example Computer System

In example embodiments, the components, modules, systems and agents included in enterprise network 110, CRM support system 120 and CRM system 200 can be implemented using one or more computer devices, servers or systems that each include a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a digital signal processor, or another hardware processing circuit.

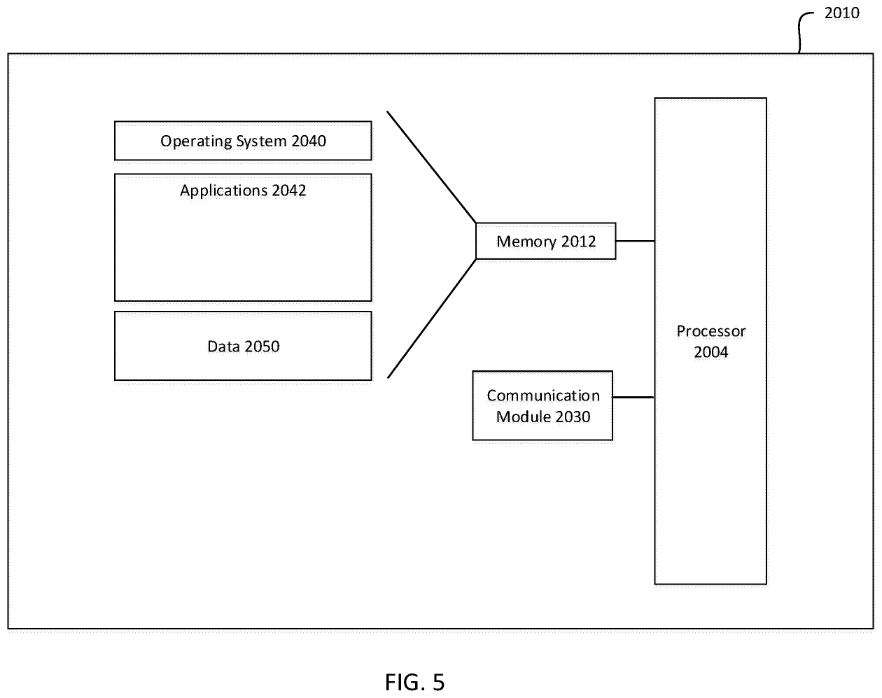

Referring to FIG. 5, an example embodiment of a computer system 2010 for implementing one or more of the modules, systems and agents included in enterprise network 110, CRM support system 120 and CRM system 200 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 202 executed by the processor 2004 are also stored in the persistent memory. The applications 2042 can include software instructions for implementing the systems, methods, agents and modules described above.

The system 2010 is configured to store data that may include data objects 101 (in the case of CRM system 200) and customer data (in the case of CRM support system 120).

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method, comprising:
generating an electronically stored opportunity pattern database storing opportunity data for a plurality of reference opportunities between a first enterprise and a plurality of external entities, each reference opportunity corresponding to a respective external entity and having a respective opportunity timeline that is defined by a series of opportunity timeline periods between a respective start date for the reference opportunity and a respective closing date for the reference opportunity, wherein generating the opportunity pattern database comprises:
storing, for each reference opportunity, opportunity participant data that identifies participants from the first enterprise and participants from the external entity for the reference opportunity, the participant data identifying respective email addresses for the participants;
automatically extracting email address and email timestamp data for electronic communications that are exchanged through a mail server between a first enterprise and each of the plurality of external entities;
automatically extracting meeting event data about meeting events from one or both of: (i) the electronic communications exchanged through the mail server, and (ii) electronically stored calendar application data of the first enterprise, the extracted meeting event data for each meeting event identifying meeting event participants and a meeting event date;
matching the electronic communications and meeting events to respective reference opportunities and the respective opportunity timeline periods thereof based on the extracted email address and email timestamp data, the extracted meeting event data, and the stored opportunity participant data;
computing and storing, based on the matching, as part of the opportunity data, for each for each timeline period for each reference opportunity, a corresponding communication activity feature including attributes that represent (i) a number of electronic email communications exchanged during the opportunity timeline period between the first enterprise and the respective external entity, and (ii) a number of meeting events during the opportunity timeline period between the first enterprise and the respective external entity;
providing a recommendation in respect of a target timeline period for a target opportunity corresponding to a target entity, comprising, during the target timeline period:
automatically extracting further email address and email timestamp data for further electronic communications that are exchanged through the mail server;
automatically extracting further meeting event data about further meeting events from one or both of: (i) the further electronic communications exchanged through the mail server, and (ii) the electronically stored calendar application data of the first enterprise, the extracted further meeting event data identifying, for each further meeting event, further meeting event participants and a further meeting event date;
matching the further electronic communications and further meeting events to the target opportunity and the target timeline period based on the extracted further email address and email timestamp data, the extracted further meeting event data, and stored target opportunity participant data;
computing, based on the matching of the further electronic communications and further meeting events to the target opportunity and the target timeline period, a target activity feature including attributes that represent (i) a number of electronic email communications exchanged between the first enterprise and the target entity, and (ii) a number of meetings events between the first enterprise and the target entity;
selecting, from the opportunity pattern database, a set of the communication activity features for respective opportunity timeline periods that each correspond to the target timeline period;
computing, based on the attributes of the selected set of communication activity features, target timeline period threshold attributes for (i) exchanged electronic email communications between the first enterprise to the target entity and (ii) meeting events scheduled between the first enterprise and the target entity;
comparing the target timeline period threshold attributes to the respective attributes of the target activity feature; and
generating, via a user interface, a feedback message recommending a next action to be performed in respect of the target entity based on the comparing.

2. The method of claim 1 wherein the reference opportunities are each successfully closed opportunities and communication activity features stored in respect of each of the plurality of closed opportunities are part of a respective set of opportunity features that form a respective opportunity pattern stored for each of the closed opportunities, the method comprising:
determining a target pattern for the target opportunity by applying a set of predefined functions to data collected in respect of the target opportunity to generate a respective set of target features that numerically represent the target opportunity, the target features including a plurality of different type of features including the target activity feature; and
selecting, based on a comparison of a first subset of the opportunity features with a corresponding first subset of the target features, opportunity patterns that are similar to the target pattern,
wherein the set of the communication activity features that correspond to a same respective opportunity timeline period as the target timeline period are selected from the selected opportunity patterns.

3. The method of claim 2 wherein the stored opportunity patterns are each respectively generated by applying the same set of predefined functions applied to the data collected in respect of the target opportunity to data collected in respect of each of the respective closed opportunities.

4. The method of claim 2 wherein the target features and the opportunity features each include types of features that are static features and types of features that are dynamic features, wherein static features represent properties that are expected to remain the same over a duration of an opportunity and dynamic features represent properties that are expected to change over the duration of the opportunity, wherein the communication activity features and the target activity feature are each dynamic features.

5. The method of claim 4 wherein the first subset of the set of target features includes one or more static features.

6. The method of claim 5 where in the first subset of the set of target features excludes dynamic features.

7. The method of claim 2 wherein selecting the set of similar opportunity patterns comprises performing a k-nearest neighbor algorithm to select the k-nearest opportunity patterns based on the first subset of the set of target features and the same-type features of the opportunity patterns of the closed opportunities.

8. The method of claim 1 wherein generating the feedback message comprises sending a message through a network to a remote computer system that implements the user interface for access by a user.

9. The method of claim 1 wherein computing the target timeline period threshold attributes is based on averaging values of corresponding attributes included in the selected set of communication activity features.

10. A system comprising:
computer hardware configured to perform operations comprising:
generating an electronically stored opportunity pattern database storing opportunity data for a plurality of reference opportunities between a first enterprise and a plurality of external entities, each reference opportunity corresponding to a respective external entity and having a respective opportunity timeline that is defined by a series of opportunity timeline periods between a respective start date for the reference opportunity and a respective closing date for the reference opportunity, wherein generating the opportunity pattern database comprises:
storing, for each reference opportunity, opportunity participant data that identifies participants from the first enterprise and participants from the external entity for the reference opportunity, the participant data identifying respective email addresses for the participants;
automatically extracting email address and email timestamp data for electronic communications that are exchanged through a mail server between a first enterprise and each of the plurality of external entities;
automatically extracting meeting event data about meeting events from one or both of: (i) the electronic communications exchanged through the mail server, and (ii) electronically stored calendar application data of the first enterprise, the extracted meeting event data for each meeting event identifying meeting event participants and a meeting event date;
matching the electronic communications and meeting events to respective reference opportunities and the respective opportunity timeline periods thereof based on the extracted email address and email timestamp data, the extracted meeting event data, and the stored opportunity participant data;
computing and storing, based on the matching, as part of the opportunity data, for each for each timeline period for each reference opportunity, a corresponding communication activity feature including attributes that represent (i) a number of electronic email communications exchanged during the opportunity timeline period between the first enterprise and the respective external entity, and (ii) a number of meeting events during the opportunity timeline period between the first enterprise and the respective external entity;
providing a recommendation in respect of a target timeline period for a target opportunity corresponding to a target entity, comprising, during the target timeline period:
automatically extracting further email address and email timestamp data for further electronic communications that are exchanged through the mail server;
automatically extracting further meeting event data about further meeting events from one or both of: (i) the further electronic communications exchanged through the mail server, and (ii) the electronically stored calendar application data of the first enterprise, the extracted further meeting event data identifying, for each further meeting event, further meeting event participants and a further meeting event date;
matching the further electronic communications and further meeting events to the target opportunity and the target timeline period based on the extracted further email address and email timestamp data, the extracted further meeting event data, and stored target opportunity participant data;
computing, based on the matching of the further electronic communications and further meeting events to the target opportunity and the target timeline period, a target activity feature including attributes that represent (i) a number of electronic email communications exchanged between the first enterprise and the target entity, and (ii) a number of meetings events between the first enterprise and the target entity;
selecting, from the opportunity pattern database, a set of the communication activity features for respective opportunity timeline periods that each correspond to the target timeline period;
computing, based on the attributes of the selected set of communication activity features, target timeline period threshold attributes for (i) exchanged electronic email communications between the first enterprise to the target entity and (ii) meeting events scheduled between the first enterprise and the target entity;
comparing the target timeline period threshold attributes to the respective attributes of the target activity feature; and
generating, via a user interface, a feedback message recommending a next action to be performed in respect of the target entity based on the comparing.

11. A computerized recommendation system comprising:
an automated monitoring agent configured to interface with one or more electronic mail servers and calendar applications associated with a first enterprise and selectively extract email address and email timestamp data for electronic communications that are exchanged through the mail server between the first enterprise and a plurality of external entities and extract meeting event data about meeting events between the first enterprise and a plurality of external entities, the extracted meeting event data for each meeting event identifying meeting event participants and a meeting event date;
an automated system for generating and storing opportunity data for a plurality of opportunities of the first enterprise with each of the plurality of external entities, each opportunity corresponding to a respective external entity and having a respective opportunity timeline that is defined by a series of opportunity timeline periods between a respective start date for the opportunity and a respective closing date for the opportunity, the plurality of opportunities including a plurality of closed opportunities and a ongoing target opportunity for one of the external entities that is a target entity,
the automated system being configured to:
receive the extracted email address and email timestamp data and meeting event data from the automated monitoring agent and generate, for each opportunity timeline period for each of the plurality of opportunities, a respective communication activity feature including attributes that represent: (i) a number of electronic email communications exchanged during the opportunity timeline period between the first enterprise to the respective external entity corresponding to the opportunity, and (ii) a number of meeting events during the opportunity timeline period between the first enterprise and the respective external entity corresponding to the opportunity;
select, from the communication activity features generated in respect of the plurality of closed opportunities, a set of closed opportunity communication activity features that correspond to a target opportunity timeline period of the ongoing target opportunity;
compute, based on the attributes of the selected set of communication activity features, target opportunity timeline period threshold attributes for (i) a number of electronic email communications exchanged during the target opportunity timeline period between the first enterprise and the target entity corresponding to the opportunity, and (ii) a number of meeting events during the target opportunity timeline period between the first enterprise and the respective external entity corresponding to the opportunity;
compare the target opportunity timeline period threshold attributes to the communication activity feature generated for the target opportunity for the target opportunity timeline period; and
generate, for output by a user interface device, a feedback message recommending a next action to be performed in respect of the target opportunity based on the comparing.
